(19) United States
(12) Patent Application Publication
(10) Pub. No.: US 2002/0191363 A1
(43) Pub. Date: Dec. 19, 2002

(54) Electrical circuit-breaker with an information memory

(76) Inventors: Andreas Krauss, Berlin (DE); Andreas Pancke, Berlin (DE)

Correspondence Address: MORRISON & FOERSTER LLP, 2000 PENNSYLVANIA AVE, NW, SUITE 5500, WASHINGTON, DC, 20006-1888, US

(21) Appl. No.: 10/149,370

(22) PCT Filed: Nov. 29, 2000
(86) PCT No.: PCT/DE00/04323

(30) Foreign Application Priority Data
Dec. 7, 1999 (DE) 299 21 791.4

(51) Int. Cl. H01H 73/00

(52) U.S. Cl. 361/115

(57) ABSTRACT

The invention relates to a circuit breaker with comprising flow sensors for determine measuring flowing through switching, and an electronic overcurrent release device for processing signals pertaining to the flow sensors. An information memory embodied as a Memory Button transfers characteristic values pertaining to the circuit breaker and/or flow sensors to the overcurrent release device. Various additional functions, e.g. registration of unusual procedures including date permissible number of make-break operations are also possible.

The invention relates to an electrical circuit breaker with the following components:

a mechanical assembly with at least one switching contact one drive apparatus operating the switching contact, and associated latching devices in order to release energy stores for closing and opening the switching contact,

a current sensor for detection of a current flowing via the switching contact,

an electronic overcurrent release for processing a signal from the current sensor and for emitting a signal in order to release the latching device for opening of the switching contact, and, furthermore,

an information memory for passing characteristic values of the current sensor and/or of the electromechanical assembly of the circuit breaker to the overcurrent release.

Current transformers and/or current sensors which emit a measurement value to the overcurrent release are arranged in circuit breakers. An overcurrent release such as this may in this case be used in any desired circuit breaker, irrespective of its rated current. However, it must be matched to the circuit breaker, with regard to the desired user settings. For this purpose, this system has an information memory by means of which the switch data, for example the rated current of the circuit breaker and the values of the secondary currents of the current transformers (50 mA corresponding, for example, to 1600 A), is supplied to the overcurrent release.

The data for the circuit breaker, such as the switching rating class, the physical size and the like, must be coded permanently in the circuit breaker in order that the electronic overcurrent release can carry out its protective tasks in the desired manner. In this case, the expression switching rating class means the switching capacity as classified in specific categories, such as a low, medium or high switching capacity. The highest switching rating class generally has a current limiting function. Since this allows automatic opening of individual poles of the circuit breaker under the influence of a short-circuit current, the overcurrent release must ensure that the entire switching mechanism is moved correctly to the disconnected position in order that all the remaining poles are also opened.

If there is any need to replace the electronic overcurrent release, it is necessary to ensure that the information that is typical of the circuit breaker is still available. For this reason, this data cannot be stored in the electronic overcurrent release. The data must be stored on a “switch-resident” basis, in order that the necessary switch data can be supplied to a replacement overcurrent release once it has been installed in the circuit breaker.

A circuit breaker such as this has already been described in WO 97/08725 A1. In this switch, the information memory is arranged detachably on the outside of the housing of the overcurrent release. The arrangement of the information memory on the overcurrent release means that the information memory is also included in any check of an overcurrent release after it has been removed from the circuit breaker and that any faults that may have occurred in the information memory are also recorded. With this procedure, it is assumed that, when the current transformer in the circuit breaker is replaced, the information memory must also be replaced, or its programming must be adapted.

An arrangement according to EP 0 493 272 B1 (which corresponds to U.S. Pat. No. 5,331,500), in which an interface card is provided to which firstly the current transformers and secondly the overcurrent release must be connected, requires similar measures. The interface card is mounted permanently on the supporting mechanism for the circuit breaker such that an operative connection to the electronic release is produced only when the release is inserted into the circuit breaker. The signals from the current transformer are transmitted to the release by means of lines through which the current transformers are connected to the interface card. This provides the release with information about the characteristics of the circuit breaker. This interface card comprises, inter alia, a mount on which a printed circuit is arranged, on which further components are provided. It is thus relatively complex.

The object of the present invention is to ensure the provision of basic data for an electrical circuit breaker and that this basic data is passed to the electronic overcurrent release such that this process necessarily takes place when the overcurrent release is replaced, but with little effort being involved.

This object is achieved according to the invention in that a two-wire memory element, which is known per se as a memory button, is provided as an information memory for the switch-specific characteristic values in the circuit breaker, and in that the memory element is combined with components of a plug-in apparatus or with a connecting line or cable harness that is part of that component. The name memory button is derived firstly from a memory function, and secondly from a housing shape, which corresponds to that of known button batteries. The memory elements of said type accordingly have only two electrical contact surfaces or connecting surfaces, which are used for all the intended functions, such as the reading and writing of data, as well as the power supply.

Said memory element may advantageously be arranged in the cable harness between the electronic overcurrent release and the circuit breaker, which means that it is not permanently fitted in the circuit breaker. However, it may expediently also be arranged in the plug connector of the flexible connecting line between the circuit breaker and the electronic overcurrent release, or in a separate plug, which is generally referred to as a “rating plug” (rated current plug). The simple connection technique by means of generally only two connecting lines allows permanent storage of parameters for the circuit breaker in a very simple manner.

In addition to the coded information, this memory element allows some of the functionality to be removed from the actual electronic overcurrent release and to be carried out by the memory element, in addition to the actual task of storing coded switch data. For example, one embodiment of the memory element is available which includes a real time clock. In addition to producing the time stamp for various logic functions, this allows, for example, the thermal memory of the electronic overcurrent release to be implemented.

This thermal memory is classically used to ensure, following tripping resulting from a long-term overload, that the process of reconnection takes account of whether there is still any residual heat in the connected load and whether, in consequence, the tripping time must be shortened in the event of renewed overloading.

Furthermore, if the memory capacity of the memory element is sufficient, an electronic switching operation counter can be provided for the circuit breaker. This function has until now been carried out by the electronic overcurrent release, which can thus be relieved of this load by the removal of the said function, which may lead to a reduction in the price of the electronic overcurrent release.

The reasons for tripping may also be stored together with the date and time as well as the maximum parameters that have occurred, such as peak currents. In the event of a fault in the circuit breaker, this may provide important information for maintenance, and possibly for the customer as well. Thus, by way of example, serious events influencing the life of the circuit breaker, such as tripping as a result of a very high short-circuit current, for example, may be stored permanently in this memory element, together with a time stamp and the number of switching operations. Data such as this makes it easier to reconstruct circumstances leading to damage to the circuit breaker than using previous means.

Furthermore, the tripping parameters may be stored and may be used to allow the customer to be provided automatically with all the parameters from the old overcurrent release for setting in the new current release once an overcurrent release has been replaced, provided these parameters are adjustable. This wish can be implemented, for example, by an additional menu item in the overcurrent release or by a small button “transfer stored data from the circuit breaker”.

The invention will be explained in more detail in the following text with reference to the associated drawing and, in order to assist understanding, on the basis of one preferred exemplary embodiment, although this does not restrict the scope of the patent.

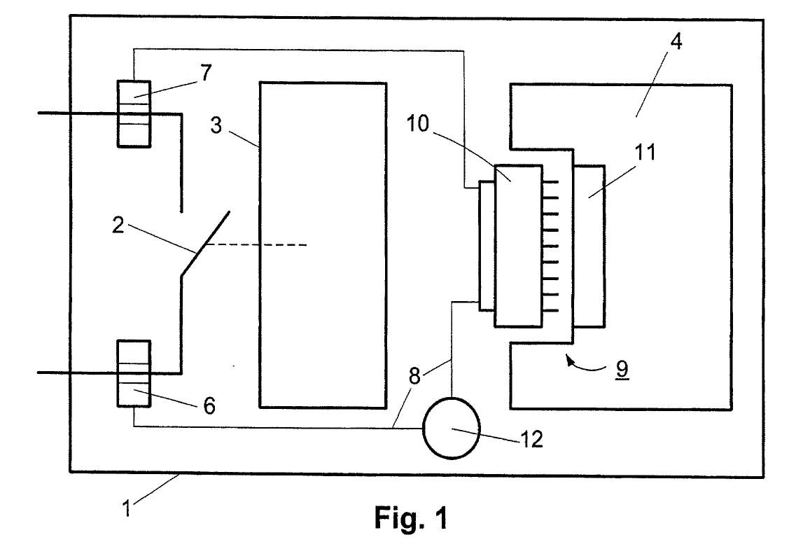

FIG. 1 shows, schematically, the main components of a circuit breaker in which the information memory according to the invention is arranged in the cable harness between the electronic overcurrent release and the circuit breaker.

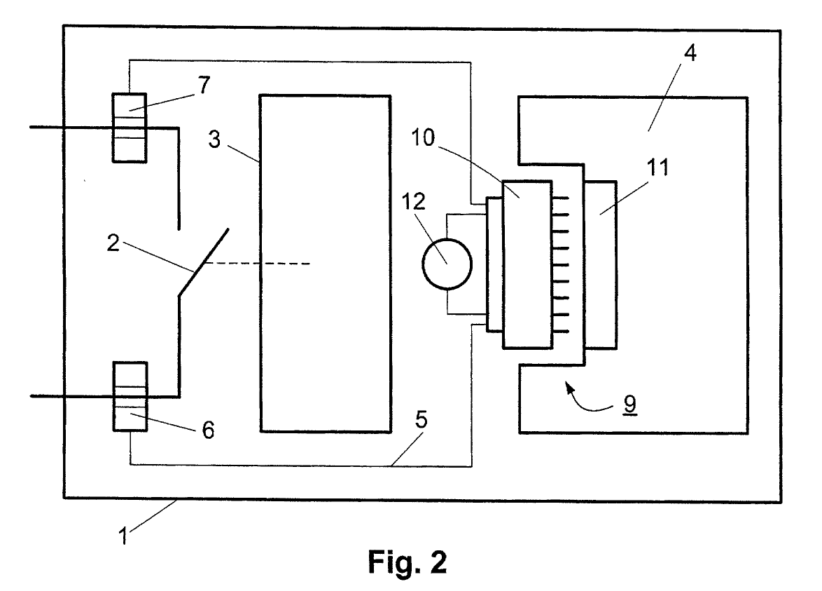

FIG. 2 shows, schematically, the main components of a circuit breaker in which the information memory according to the invention is arranged such that it is integrated in the plug connector of the flexible connecting line between the circuit breaker and the electronic overcurrent release.

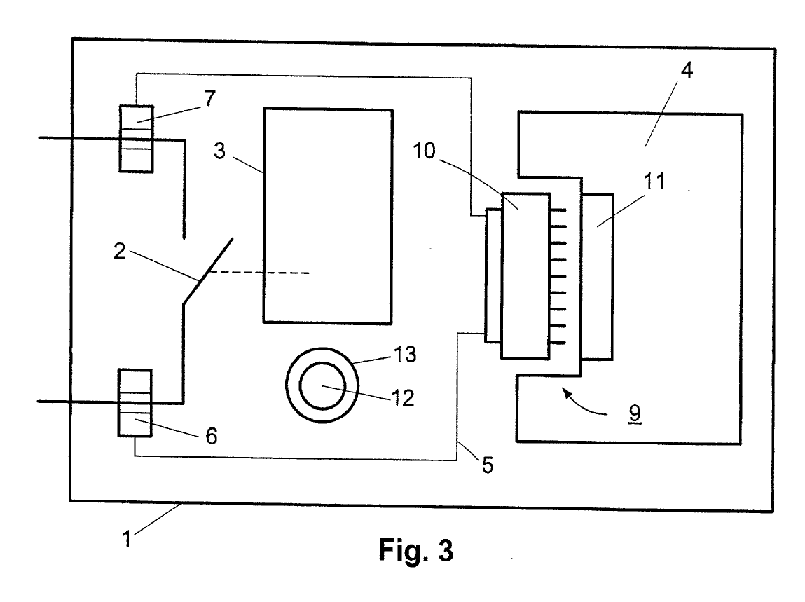

FIG. 3 shows, schematically, the main components of a circuit breaker in which the information memory according to the invention is arranged in a separate plug, generally referred to as a rating plug.

FIG. 1 shows, schematically and in the form of a single-pole representation, the main components of a low-voltage circuit breaker 1. This contains a switching contact 2 and a drive apparatus 3 which operates it. This includes spring energy stores and latching mechanisms which are not illustrated, which can be operated manually or by remote control, in order to close or to open the switching contact 2. Furthermore, the low-voltage circuit breaker 1 contains an electronic overcurrent release 4 which, in a known manner, forms a protective device in order to open the switching contact 2 when predetermined conditions occur. For this purpose, the electronic overcurrent release 4 is connected to a current sensor 6 by means of a cable harness 8. Furthermore, either likewise from the current sensor 6 or from some other energy transducer 7 that is also provided, it receives auxiliary energy that is required to evaluate the measurement values. Depending on the number of poles in the low-voltage circuit breaker 1, one or more current sensors 6 and, if appropriate, energy transducers 7, are provided. A first component 10 of a two-part plug-in apparatus 9 is fitted at the end of the cable harness 8, the associated second component 11 of which two-part plug-in apparatus is arranged on the electronic overcurrent release 4. This plug connection 9 is used for problem-free disconnection of the low-voltage circuit breaker 1 and overcurrent release 4 for replacement. In order that a specific combination of characteristic values for the low-voltage circuit breaker 1 is available again in this situation after replacement of the overcurrent release 4, the memory element 12 of the information memory is, according to the invention, arranged in said cable harness 8.

FIG. 2 shows, likewise schematically and in the form of a single-pole representation, the main components of a low-voltage circuit breaker 1. Like FIG. 1 as well, this contains a switching contact 2 and a drive apparatus 3 which operates it. This includes spring energy stores and latching mechanisms which are not illustrated, which can be operated manually or by remote control, in order to close or to open the switching contact 2. Furthermore, the low-voltage circuit breaker 1 contains an electronic overcurrent release 4 which, in a known manner, forms a protective device in order to open the switching contact 2 when predetermined conditions occur. For this purpose, the electronic overcurrent release 4 is connected to a current sensor 6 by means of a flexible connecting line 5. Furthermore, it receives auxiliary energy, which is required for evaluation of the measurement values, either likewise from the current sensor 6 or from some other additionally provided energy transducer 7. Depending on the number of poles in the low-voltage circuit breaker, one or more current sensors 6 and, if required, energy transducers 7 are provided.

A first component 10 of a two-part plug-in apparatus is fitted at the end of the flexible connecting line 5, and the associated second component 11 of this two-part plug-in apparatus is arranged on the electronic overcurrent release. Here, the first component 10 at the same time forms an information memory for important characteristic values of the low-voltage circuit breaker 1. For this purpose, according to the present invention, the memory element 12 is connected between the two contact pins of the first component 10 of the two-part plug-in apparatus. This memory element 12 represents a specific combination of characteristic values of the low-voltage circuit breaker 1, which are thus once again available to the overcurrent release 4, after the connection of the two-part plug-in apparatus, when the overcurrent release 4 is replaced.

FIG. 3 shows, once again schematically and in the form of a single-pole representation, the main components of a low-voltage circuit breaker 1. This also contains a switching contact 2 and a drive apparatus 3 which operates it. This includes spring energy stores and latching mechanisms which are not illustrated, which can be operated manually or by remote control, in order to close or to open the switching contact 2. The low-voltage circuit breaker 1 furthermore contains an electronic overcurrent release 4 which, in the known manner, forms a protective device in order to open the switching contact 2 when predetermined conditions occur. For this purpose, the electronic overcurrent release 4 is connected to a current sensor 6 by means of a flexible connecting line 5. Furthermore, it receives auxiliary energy, which is required for evaluation of the measurement values, either likewise from the current sensor 6 or from some other additionally provided energy transducer 7. One or more current sensors 6 and, if required, energy transducers 7 are provided, depending on the number of poles in the low-voltage circuit breaker 1.

A first component 10 of a two-part plug-in apparatus 9 is fitted at the end of the flexible connecting line 5, and the associated second component 11 of this two-part plug-in apparatus is arranged on the electronic overcurrent release 4. This plug connection is used for problem-free disconnection of the low-voltage circuit breaker 1 and overcurrent release 4 in the event of replacement. The memory element 12, which is provided for storing and providing the characteristic values of the low-voltage circuit breaker 1, in the information memory is in this embodiment combined with a separate plug-in apparatus 13, which is provided in the low-voltage circuit breaker 1 and carries out the functions which are known from the name rating plug.

The advantages of the solution according to the invention are its low-cost solution, and increased functions of the overall system. By way of example, memory buttons of the “Dallas Semiconductors DS 1992/93/94/95” type are suitable for the purposes of the invention.

1. An electrical circuit breaker with the following components:
a mechanical assembly with at least one switching contact (2), one drive apparatus (3) operating the switching contact (2) and associated latching devices in order to release energy stores for closing and opening the switching contact (2),
a current sensor (6) for detection of a current flowing via the switching contact (2),
an electronic overcurrent release (4) for processing a signal from the current sensor (6) and for emitting a signal in order to release the latching device for opening of the switching contact (2), and, furthermore,
an information memory (12) for passing characteristic values of the current sensor (6) and/or of the electromechanical assembly of the low-voltage circuit breaker (1) to the overcurrent release (4),
characterized
in that the two-wire memory element (12), which is known per se as a memory button, is provided as the information memory for the switch-specific characteristic values in the circuit breaker and in that the memory element (12) is combined with a component of a plug-in apparatus (9; 13) or with a connecting line (5) or cable harness (8) which is part of that component.

2. The electrical circuit breaker as claimed in claim 1,
characterized
in that the memory element (12) is arranged in a cable harness (8) between the electronic overcurrent release (4) and the circuit breaker (1).

3. The electrical circuit breaker as claimed in claim 1,
characterized
in that the memory element (12) is arranged such that it is integrated
in a first component (10) of a two-part plug-in apparatus at the end of a flexible connecting line (5), whose associated second component (11) is fitted to the electronic overcurrent release (4).

4. The electrical circuit breaker as claimed in claim 1,
characterized
in that the memory element (12) is arranged in a separate plug-in apparatus (9) provided in the circuit breaker (1).
